(19) United States
(12) Patent Application Publication
(10) Pub. No.: US 2025/0356642 A1
(43) Pub. Date: Nov. 20, 2025

(54) Classification of Image Data from Synthetic Aperture Radar Images and Electro-Optical Images with Multi-Modal Fusion

(71) Applicant: AtomBeam Technologies Inc., Moraga, CA (US)

(72) Inventors: Zhu Li, Overland Park, KS (US); Paras Maharjan, Kansas City, MO (US)

(21) Appl. No.: 19/204,458

(22) Filed: May 9, 2025

Related U.S. Application Data
(63) Continuation-in-part of application No. 18/665,235, filed on May 15, 2024.

(51) Int. Cl. G06V 10/80; G01S 13/90; G06T 7/33; G06V 10/24; G06V 10/75; G06V 10/82; G06V 10/84

(52) U.S. Cl. CPC G06V 10/806; G01S 13/9027; G06T 7/33; G06V 10/24; G06V 10/755; G06V 10/82; G06V 10/84; G06T 2207/10044

(57) ABSTRACT

Systems and methods are disclosed for classifying objects using electro-optical and synthetic aperture radar images through multi-modal feature alignment and fusion. A computing system acquires and preprocesses image data, then aligns features across modalities using a multi-modal alignment engine. A cross-modal attention fusion network extracts and integrates complementary information using transformer-based attention mechanisms. A modality-specific feature extraction framework processes EO and SAR images through specialized branches, ensuring optimal feature representation. An adaptive fusion decision system dynamically determines the best fusion strategy based on image quality and confidence scores. A self-supervised consistency controller enforces alignment between EO and SAR features using contrastive learning. The fused representations are processed by a neural network to generate object classifications. This system improves accuracy and robustness in environments where one modality may be degraded or missing, enhancing applications such as remote sensing, surveillance, and autonomous navigation.

### CROSS-REFERENCE TO RELATED APPLICATIONS

Priority is claimed in the application data sheet to the following patents or patent applications, each of which is expressly incorporated herein by reference in its entirety:
18/665,235

### BACKGROUND OF THE INVENTION

### Field of the Art

The present invention is in the field of image processing and multi-modal data fusion, and more particularly is directed to the problem of integrating and classifying objects in synthetic aperture radar images and electro-optical images through feature-level registration and adaptive fusion techniques.

### Discussion of the State of the Art

Electro-optical (EO) imagery is widely used in applications such as environmental monitoring, surveillance, infrastructure assessment, and autonomous navigation. EO sensors capture high-resolution images based on visible light, providing detailed texture and color information that is useful for object recognition and classification. However, EO imagery has inherent limitations, including sensitivity to lighting conditions, atmospheric interference, and cloud cover, which can degrade image quality or render some data unusable.

Synthetic aperture radar (SAR) imagery complements EO imagery by using radar waves to capture images, making it resilient to adverse weather, darkness, and obstructions like smoke or haze. SAR operates at various wavelengths, including X-band, C-band, L-band, and P-band, allowing for deep penetration into environmental layers. It is widely used for remote sensing, military reconnaissance, disaster monitoring, and mapping applications. Despite these advantages, SAR imagery lacks the fine-grained color and texture details of EO images, and interpreting SAR data requires specialized techniques due to noise and geometric distortions inherent to radar-based imaging.

Both EO and SAR images offer unique advantages, but integrating them effectively for object classification remains a significant challenge. Differences in spatial resolution, viewpoint, and acquisition timing can cause misalignment between EO and SAR data. Additionally, the two modalities often lack direct pixel-level correspondence, making fusion difficult. Furthermore, current classification techniques struggle with image degradation, missing data, and variations in environmental conditions, leading to reduced accuracy in automated recognition tasks.

What is needed is a multi-modal fusion system that integrates EO and SAR imagery at the feature level, aligning their representations while preserving their unique advantages. Such a system should perform automated feature registration, leverage attention-based fusion techniques, and dynamically adapt to varying image quality to improve classification accuracy in complex imaging conditions.

### SUMMARY OF THE INVENTION

The inventor has conceived and reduced to practice a system and method for multi-modal fusion in image classification, utilizing both electro-optical (EO) and synthetic aperture radar (SAR) imagery. This system introduces a multi-modal alignment engine, cross-modal attention fusion network, and adaptive fusion decision system to improve classification accuracy, especially in challenging conditions. The system enables effective integration of EO and SAR data by performing feature-level alignment, modality-specific feature extraction, and uncertainty-aware fusion strategies, ensuring robust object classification across various environments.

In a preferred embodiment, a computer system is provided for image classification, comprising a memory and a processor executing software instructions to acquire EO and SAR images, preprocess the images, and perform feature alignment through a multi-modal alignment engine. The alignment engine registers EO and SAR images at the feature level using deformable convolutions and deep feature matching, ensuring spatial alignment without requiring precise pixel registration.

In a preferred embodiment, the system further comprises a cross-modal attention fusion network that applies bi-directional attention mechanisms between EO and SAR feature spaces. The network captures complementary information, dynamically weights features based on their relevance, and enhances feature representations before input to a neural network backbone layer. The backbone layer, which may be implemented as a ResNet-34, EfficientNet-B0, or Swin-T architecture, extracts high-level features from the fused EO-SAR data.

In a preferred embodiment, an adaptive fusion decision system dynamically determines the optimal fusion strategy based on image quality and confidence metrics. This system employs Bayesian neural networks for uncertainty estimation, entropy-based weighting mechanisms, and gating networks that adjust the contribution of each modality. By compensating for missing or degraded data in either EO or SAR images, the adaptive fusion decision system ensures classification reliability under varying conditions.

In an embodiment, the system includes a modality-specific feature extraction framework that enhances a neural network architecture. This framework consists of parallel branches optimized for EO and SAR data, utilizing SAR-specific filters to mitigate speckle noise and EO-specific extractors for color and texture information. Modality-specific normalization ensures compatibility between EO and SAR features before fusion.

In an embodiment, a self-supervised consistency controller applies contrastive learning objectives to maintain semantic consistency between EO and SAR representations. This controller leverages cross-modal consistency losses and bidirectional reconstruction techniques to improve model robustness to domain shifts. Additionally, enhanced triplet mining incorporates cross-modal relationships to refine feature embeddings and classification accuracy.

In an aspect of an embodiment, the system employs cross-attention mechanisms within the fusion network, utilizing transformer-based attention blocks with query-key-value operations. Multi-head attention enables fine-grained integration of EO and SAR features, while scaled dot-product calculations dynamically determine the relevance of features across modalities.

In an embodiment, the multi-modal alignment engine performs correlation-based feature matching and spatial transformer network operations to align EO and SAR images. By focusing on feature correspondences instead of raw pixel alignment, the system achieves improved generalization across different imaging conditions.

In an embodiment, the adaptive fusion decision system incorporates information bottleneck techniques to filter out redundant or noisy features before fusion. This system ensures that only the most relevant features contribute to classification decisions, thereby improving efficiency and accuracy.

In an embodiment, the system optimizes computational efficiency through conditional computation paths, feature pruning, and quantization-aware training. These enhancements enable deployment in real-time and edge-computing environments without compromising classification performance.

### BRIEF DESCRIPTION OF THE DRAWING FIGURES

FIG. 1 is a block diagram illustrating components for image classification utilizing EO image data and SAR image data, according to an embodiment.

FIG. 2 is a block diagram showing a network architecture, according to an embodiment.

FIG. 3 is a diagram of a neural network with a triplet loss component, according to an embodiment.

FIG. 4 shows exemplary EO image data and corresponding SAR image data, according to an embodiment.

FIG. 5 is a flow diagram illustrating an exemplary method for image classification utilizing EO image data and SAR image data, according to an embodiment.

FIG. 6 is a block diagram illustrating exemplary architecture of multi-modal fusion system.

FIG. 7 is a method diagram illustrating the multi-modal fusion pipeline of multi-modal fusion system.

FIG. 8 is a method diagram illustrating the feature-level registration process performed by multi-modal alignment engine.

FIG. 9 is a method diagram illustrating the cross-modal attention mechanism employed by cross-modal attention fusion network.

FIG. 10 is a method diagram illustrating the modality-specific feature extraction branching process implemented by framework.

FIG. 11 is a method diagram illustrating the adaptive fusion decision system.

FIG. 12 is a method diagram illustrating the self-supervised consistency control process implemented by controller.

FIG. 13 is a method diagram illustrating the cross-modal triplet mining process.

FIG. 14 is a method diagram illustrating failure mode handling by the multi-modal fusion system.

FIG. 15 illustrates an exemplary computing environment on which an embodiment described herein may be implemented, in full or in part.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

The inventor has conceived and reduced to practice a system and method for multi-modal image classification that integrates electro-optical and synthetic aperture radar imagery using feature-level alignment and adaptive fusion techniques. Unlike conventional classification systems that process each modality separately, this system aligns and fuses information at a deep feature level, ensuring more accurate and robust object recognition. By addressing challenges related to spatial misalignment, modality disparities, and uncertainty in degraded conditions, the invention enhances classification performance across a wide range of imaging scenarios.

In an embodiment, the system includes an image preprocessing module that prepares EO and SAR images for processing. Standard operations such as resizing, rotation, and contrast adjustment ensure compatibility across modalities. Additional preprocessing techniques specific to multi-modal fusion, such as adaptive normalization and geometric transformations, improve feature consistency before alignment.

A multi-modal alignment engine addresses the lack of direct pixel registration between EO and SAR images. Instead of relying on traditional pixel-based alignment, which is often unreliable due to modality differences, this engine performs feature-level registration using deep feature matching and spatial transformer networks. Deformable convolutions refine the alignment by adapting to variations in object shape and imaging conditions, ensuring robust spatial correspondence.

Once aligned, the EO and SAR features are processed by a cross-modal attention fusion network. This network applies bi-directional attention mechanisms to dynamically emphasize complementary information from each modality while preserving their unique characteristics. Transformer-based query-key-value operations and multi-head attention enable fine-grained feature weighting, allowing the system to prioritize the most relevant features in different imaging conditions.

A modality-specific feature extraction framework further enhances classification accuracy by processing EO and SAR images through dedicated processing branches. EO-specific branches optimize feature extraction for texture and color, while SAR-specific branches mitigate noise and enhance structural details. These specialized pathways ensure that each modality contributes its most useful information before fusion.

An adaptive fusion decision system determines how EO and SAR features should be combined based on input quality. By analyzing uncertainty and confidence scores, the system dynamically adjusts fusion weights to account for missing or degraded data. Bayesian neural network components, entropy-based weighting, and gating mechanisms enable the system to make optimal fusion decisions under varying environmental conditions.

To ensure consistency across modalities, a self-supervised consistency controller applies contrastive learning techniques that align EO and SAR feature representations. This controller enforces semantic consistency by encouraging similar objects to have matching embeddings across modalities, even in cases where one modality is degraded. Additionally, a cross-modal triplet mining approach refines feature clustering, improving classification accuracy by separating distinct object categories.

The processed and fused feature representations are passed through a backbone neural network, which may include architectures such as ResNet-34, EfficientNet-B0, or Swin-T. These networks extract high-level features before classification layers generate object category labels, subcategories, and confidence scores. By leveraging deep fusion and adaptive decision-making, the system provides highly accurate classifications that are robust to environmental and sensor variations.

This invention represents a significant advancement over conventional classification techniques by integrating multi-modal alignment, attention-based fusion, and adaptive fusion strategies. The combination of feature-level registration, uncertainty-aware decision-making, and contrastive learning techniques ensures superior classification performance across diverse imaging conditions.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “pixel” refers to the smallest controllable element of a digital image. It is a single point in a raster image, which is a grid of individual pixels that together form an image. Each pixel has its own color and brightness value, and when combined with other pixels, they create the visual representation of an image on a display device such as a computer monitor or a smartphone screen.

The term “neural network” refers to a computer system modeled after the network of neurons found in a human brain. The neural network is composed of interconnected nodes, called artificial neurons or units, that work together to process complex information.

The term ‘synthetic aperture radar’ refers to a radar-based image acquisition technique in which a sequence of acquisitions from a shorter antenna are combined to simulate a much larger antenna, thus providing higher resolution data.

The term ‘electro-optical image’ refers to images captured with an electro-optical sensor, such as a high-resolution camera equipped with a telephoto zoom lens. The sensor detects the magnitude and color of emitted or reflected light and digitally records the information in the form of pixels.

### Conceptual Architecture

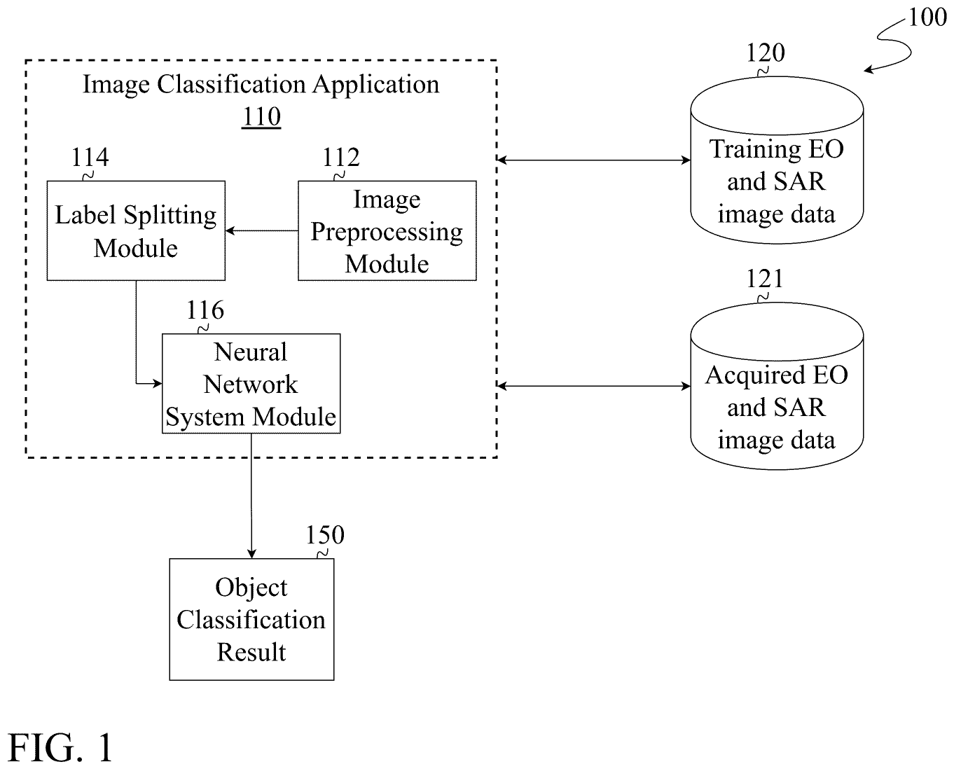

FIG. 1 is a block diagram illustrating a system 100 including components for image classification utilizing EO image data and SAR image data, according to an embodiment. The system 100 can include image classification application 110. Image classification application 110 can include one or more modules. The modules can include image preprocessing module 112. The image preprocessing module 112 can include functions and/or instructions, that when executed by a processor, cause the processor to perform one or more image preprocessing operations on input image data. The input image data can include training EO and SAR image data 120, and/or acquired EO and SAR image data 121. The training EO and SAR image data 120 can include data used to train a neural network system for object classification tasks. The acquired EO and SAR image data 121 can include image data that is provided as input to a trained neural network system to perform object classification tasks. In embodiments, the image data is in the form of pairs of EO images and corresponding SAR images. An EO image may have a similar field of view (FOV) as a corresponding SAR image in an image tuple. However, the EO image and corresponding SAR image might not have the same resolution, and may not have pixel registration with each other. The image tuple may be acquired from satellites and/or aircraft that include both EO and SAR image capturing devices onboard, enabling concurrent acquiring of EO image data and SAR image data of a given area.

The image preprocessing module 112 can include instructions to perform operations such as image resizing. In one or more embodiments, each image is resized to a predetermined size, such as 224×224, prior to being input to a neural network system. The image preprocessing module 112 can perform geometric operations. These geometric operations can include, but are not limited to, rotation, and/or flipping operations. The image preprocessing module 112 can include instructions to perform image enhancement operations, such as contrast adjustment and/or brightness adjustment. The image preprocessing module 112 may include instructions to perform an affine transform on input image data. An affine transformation is a type of geometric transformation that preserves points, straight lines, and planes. The affine transform can include a combination of translations, rotations, scales (anisotropic), and shears (skews), without any perspective distortion.

The label splitting module 114 can include functions and/or instructions, that when executed by a processor, cause the processor to augment training image data with metadata. The metadata can include category information. In one or more embodiments, the category information can include information for categories such as vehicles, buildings, geographical features, and so on. The geographical features can include features such as rivers, lakes, mountains, deserts, forests, and so on. The building types can include subcategories such as single-family dwellings, warehouses, skyscrapers, factories, and so on. The vehicle information can include subcategories such as sedan, sport-utility vehicle (SUV), pickup truck, van, box truck, motorcycle, flatbed truck, bus, trailer, pickup truck with trailer, flatbed truck with trailer, and so on. Moreover, the label splitting model 114 can include functions and/or instructions, that when executed by a processor, cause the processor to perform appearance labeling on image data. In one or more embodiments, the appearance labeling can include manual annotations and/or automated annotations that assign labels to EO image data and/or SAR image data based on the visual characteristics of the content. For example, in object detection, each object in an image may be labeled with a bounding box and a class label (e.g., “sedan,” “motorcycle,” “bus”). In one or more embodiments, the appearance labeling provides ground truth data that neural network systems of disclosed embodiments use to learn the relationships between input features (e.g., pixel values, texture, color) and the corresponding labels, enabling them to make predictions on new, unseen data, such as acquired EO and SAR image data 121 of FIG. 1.

The neural network system module 116 can include functions and/or instructions, that when executed by a processor, cause the processor to create a neural network with one or more modules, blocks, and/or layers. The layers can include a backbone layer, a first fully connected layer, and a second fully connected layer. The backbone can refer to the core architecture or structure of the network. The backbone is the main part of the network that is responsible for extracting features from the input EO and SAR image data. In embodiments, the backbone can include multiple layers of convolutional neural network (CNN) and/or other types of layers that are used for feature extraction. A fully connected layer is a type of layer in a neural network where each neuron in the layer is connected to every neuron in the preceding layer. In a fully connected layer, the output from each neuron in the preceding layer can be fed as input to each neuron in the current layer, and each connection is associated with a weight that is adjusted during the training process. The output of the neural network system can include an object classification result 150. The object classification result can include an object category, subcategory, confidence level, and/or other parameters. As an example, an object classification result can include a category of ‘vehicle,’ a subcategory of ‘pickup truck,’ and a confidence level of 0.932. The confidence level can be based on logits from an output layer. The output layer of a neural network for image classification can include a set of neurons, with each set corresponding to a class label. These neurons produce raw scores, also known as logits, which represent the network's confidence in each class. A mathematical function, such as a softmax function and/or other suitable function can be applied to the logits to convert them to probabilities.

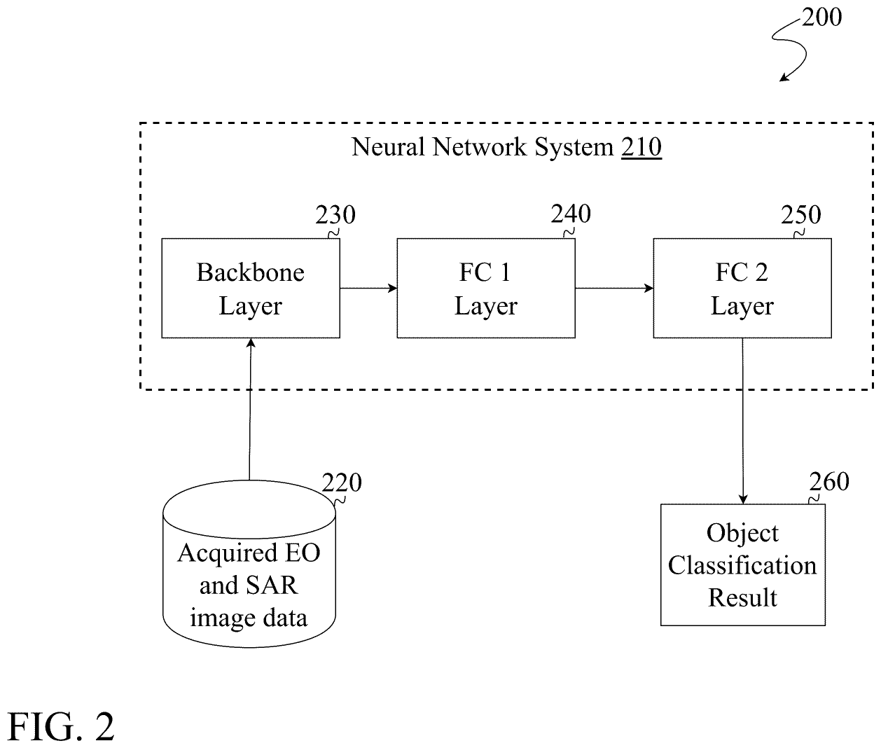

FIG. 2 is a block diagram showing a network architecture 200, according to an embodiment. The neural network architecture 200 can include neural network system 210. In one or more embodiments, the neural network system 210 may be configured and/or initialized by neural network system module 116 of FIG. 1. The neural network system 210 can include a backbone layer 230, followed by a first fully connected layer 240, and a second fully connected layer 250, configured as shown in FIG. 2. In one or more embodiments, the backbone layer 230 can include a ResNet layer. The ResNet (Residual Network) layer can include a deep convolutional neural network (CNN) that is well-suited for image classification tasks. In one or more embodiments, the backbone layer 230 can include a ResNet-34 layer. With ResNet-34, the network architecture consists of 34 layers, including convolutional layers, batch normalization layers, activation functions, and residual blocks. The network architecture is structured in a way that gradually reduces the spatial dimensions of the input while increasing the number of filters in each layer, leading to a hierarchical feature representation of the input images. The activation function can include a ReLU (Rectified Linear Unit) activation function. In embodiments, the ReLU activation function can be described mathematically as:

$$f ( x ) = max ( 0 , x )$$

where the output of the ReLU function is the maximum of 0 and the input x. If the input is greater than 0, the output is equal to the input; otherwise, the output is 0. In one or more embodiments, the activation function can include a Leaky ReLU activation function. The Leaky ReLU (Rectified Linear Unit) is a type of activation function used in artificial neural networks. It is similar to the standard ReLU function but allows a small, non-zero gradient when the input is negative, instead of setting the gradient to zero. In one or more embodiments, the Leaky ReLU activation function is defined as follows:

$$f ( x ) = \{ \begin{matrix}x , & if x > 0 \\ α x , & otherwise\end{matrix}$$

Where α is a small constant, such as 0.01, that determines the slope of the function for negative inputs. This can serve to reduce the probability of developing inactive neurons during training and/or operational use of the neural network.

In one or more embodiments, the backbone layer 230 can include an EfficientNet layer. In particular embodiments, the backbone layer 230 can include an EfficientNet-B0 layer. The “B0” in EfficientNet-B0 refers to the baseline model in the EfficientNet series, which serves as the starting point for scaling up the model to achieve better performance. In embodiments, the EfficientNet model can be scaled by increasing the network's depth, width, and resolution in an approach to find an ideal tradeoff between model size and accuracy.

In one or more embodiments, the backbone layer 230 can include a transformer layer. In particular embodiments, the backbone layer 230 can include a Swin-T layer. A Swin Transformer (Swin-T) layer is a variant of the Transformer model architecture, which has suitability for computer vision tasks. In embodiments, the Swin Transformer provides a hierarchical architecture, which processes EO and SAR images in a hierarchical manner, similar to how humans perceive visual information. Embodiments utilizing Swin-T can divide the input image into non-overlapping patches and process these patches in a series of stages, or “windows,” each of which aggregates information across different scales and resolutions. In one or more embodiments, acquired EO and SAR image data 220 is input to the backbone layer 230, through first fully connected layer 240, and second fully connected layer 250, with the output of the second fully connected layer 250 being an object classification result 260, which can include an object category, subcategory, and/or confidence level.

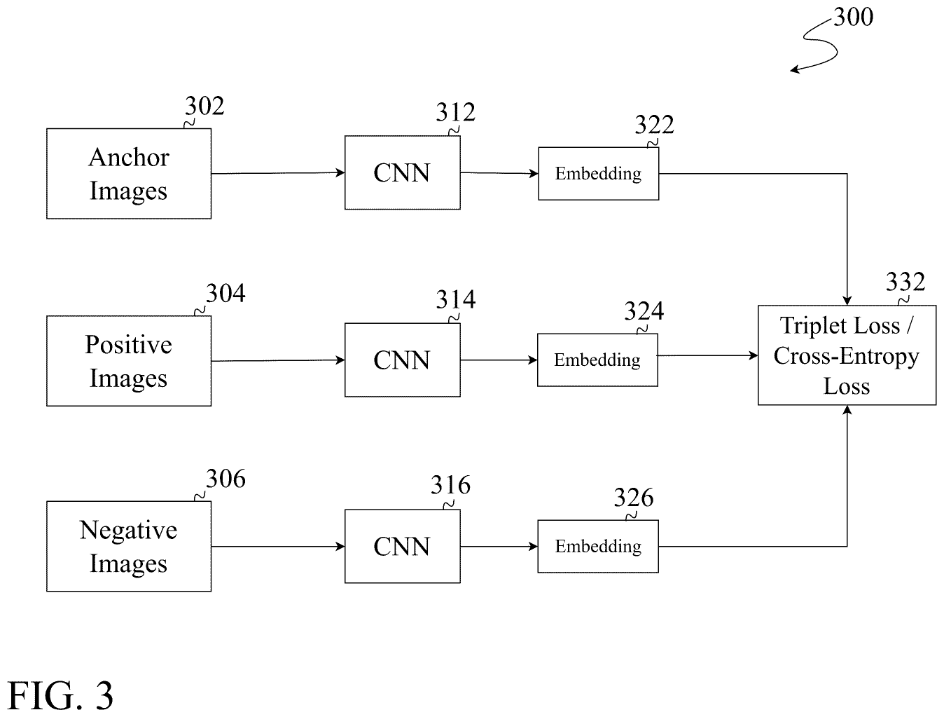

FIG. 3 is a diagram of a neural network 300 with a triplet loss component, according to an embodiment. Neural network 300 can serve as a training framework for object recognition of image tuples comprising EO image data and/or SAR image data. Training image data for neural network 300 can include anchor images 302, positive images 304, and negative images 306. The anchor images 302, positive images 304, and negative images 306 can include image tuples that include both EO image data and corresponding SAR image data. The anchor images 302 serve as reference images that form a starting point for comparing the similarity or dissimilarity of other images in the dataset. The positive images 304 include images that are similar to the anchor images in some way. For example, in vehicle type recognition, the positive images 304 can include different images of the same vehicle type as the anchor images 302. This can enable disclosed embodiments to learn to map both the anchor and positive images to similar points in an embedding space. The embedding space in image classification can refer to a lower-dimensional space where EO images and/or SAR images are represented as vectors. These vectors can include learned representations that capture important features or characteristics of the images to enable object classification. The negative images 306 include images that are dissimilar to the anchor images 302. In vehicle type identification tasks, a negative image can include an image of a different vehicle type from that included in the anchor images 302. Neural networks of disclosed embodiments are trained to map the anchor and negative images to dissimilar points in the corresponding embedding space.

As shown in FIG. 3, anchor images 302 are input to convolutional neural network (CNN) 312, which inputs to embedding space 322. Similarly, positive images 304 are input to convolutional neural network (CNN) 314, which inputs to embedding space 324, and negative images 306 are input to convolutional neural network (CNN) 316, which inputs to embedding space 326. In embodiments, the outputs of the embedding space 322, embedding space 324, and embedding space 326 are input to a triplet loss and/or cross entropy loss block 332.

Embodiments can include triplet mining. Triplet mining is a technique used in training neural networks for metric learning tasks, such as object recognition or similarity learning. The goal of triplet mining is to select informative triplets of data points (anchor, positive, and negative) that are used to train the network effectively. In triplet mining, each training example can include an anchor data point, a positive data point (similar to the anchor), and a negative data point (dissimilar to the anchor). The network is trained to minimize the distance between the anchor and positive data points (in the embedding space) while maximizing the distance between the anchor and negative data points, effectively learning to discriminate between similar and dissimilar data points. Similarly, cross-entropy loss, also known as log loss, is another loss function used in machine learning for classification tasks in disclosed embodiments. The cross-entry loss can measure the difference between two probability distributions: the predicted probability distribution output by the model and the actual probability distribution of the labels. Disclosed embodiments can utilize both triplet loss and cross-entropy loss to enhance object classification effectiveness. In one or more embodiments, the embeddings have a dimension of 512 for calculating the triplet loss.

In embodiments, a cross-entropy loss function can be denoted as L_{CE} and the triplet loss function Lₜᵣᵢₚₗₑₜ can be defined as:

$${L}_{triplet} = max ( d ( {\hat{x}}_{a} , {\hat{x}}_{p} ) - d ( {\hat{x}}_{a} , {\hat{x}}_{p} ) + margin , 0 )$$

and a multi-loss function, Lₘᵤₗₜᵢ₋ₗₒₛₛ, can be defined as a combination of the cross-entropy loss and the triplet loss as follows:

$${L}_{multi - loss} = α * {L}_{triplet} + ( 1 - α ) * {L}_{C E}$$

where \hat{x}ₐᵢ∈R^{d} is the ith feature that belongs to the yᵢth class. d, W∈R^{d×n}, and b∈R^{d} denote the feature dimension, last connected layer, and bias term, respectively, \hat{x}ₐ, \hat{x}ₚ, and \hat{x}ₙ are the anchor, positive image, and negative image, respectively. In one or more embodiments, the regularization term, or α, used for training the multi-loss loss function can be set to a value of 0.8. Other values for the regularization term may be used in some embodiments.

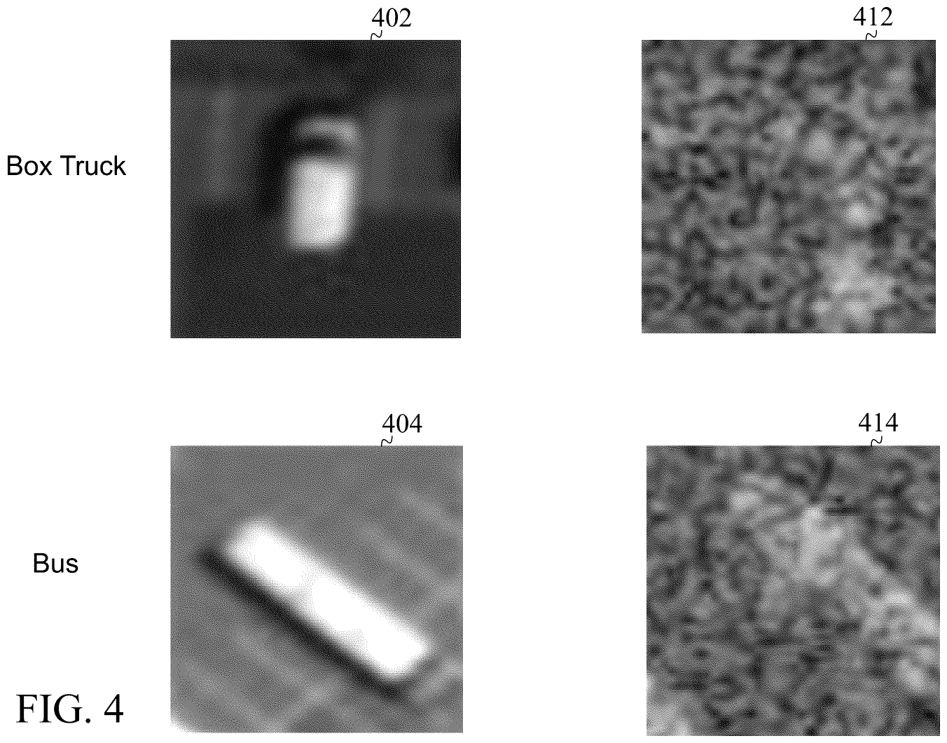

FIG. 4 shows exemplary EO image data and corresponding SAR image data, according to an embodiment. Image 402 includes an aerial EO image of a box truck. Image 412 is a corresponding SAR image of the box truck. Thus, image 402 and image 412 can form an image tuple. In another example, image 404 is an aerial EO image of a bus. Image 414 is a corresponding SAR image of the bus. Thus, image 404 and image 414 can also form an image tuple. Disclosed embodiments can operate on EO images, SAR images, and/or image tuples to perform object classification.

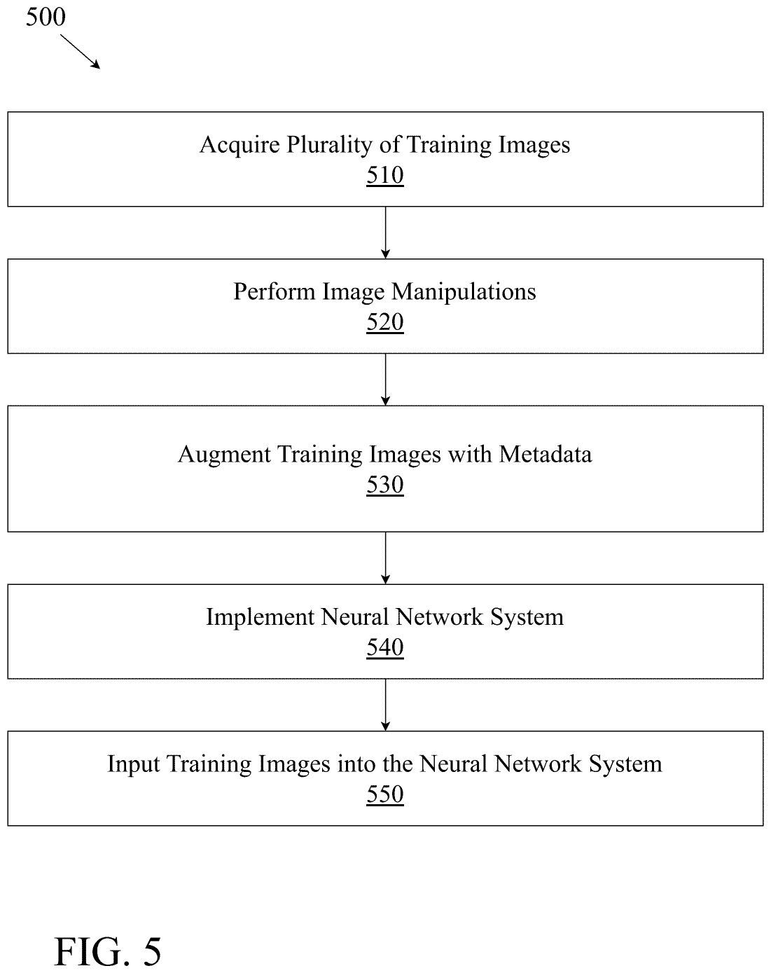

FIG. 5 is a flow diagram illustrating an exemplary method 500 for image classification utilizing EO image data and SAR image data, according to an embodiment. According to the embodiment, the process begins at step 510 where a plurality of training images are acquired. In one or more embodiments, these images can be acquired by a satellite and/or aircraft that can acquire both EO (Electro-Optical) images and SAR (Synthetic Aperture Radar) images. An example of such satellites can include Sentinel-1, which is part of the European Union's Copernicus program. The Sentinel-1 satellites are equipped with SAR sensors that provide all-weather, day-and-night radar imaging for land and ocean services. Moreover, numerous research and commercial aircraft are equipped with EO systems and SAR systems for remote sensing applications. These aircraft can acquire SAR images along with other sensors for EO imaging. The process continues to step 520 where image manipulations are performed. The image manipulations may include rotation, flipping, scaling, denoising, contrast enhancement, edge detection, resizing operations, pixel registration operations, affine transforms, and/or other suitable manipulations. The process continues to step 530 where training images are augmented with metadata. The metadata can include descriptive information, such as a category and/or subcategory. The metadata can include appearance labeling information. The metadata can include label splitting information. The label splitting information can include multiple attributes for a category, to further aid in performing object classification on acquired image data. The process continues to step 540 for the implementation of a neural network system. In one or more embodiments, the neural network system may be configured using a cloud-based machine learning platform such as Google Cloud AI Platform, Amazon SageMaker, Microsoft Azure Machine Learning, or other suitable cloud platform. One or more embodiments may utilize containerization technologies such as Docker and Kubernetes to package the neural network code and dependencies into containers. The containers may then be deployed to cloud-based container orchestration services like Amazon ECS, Google Kubernetes Engine (GKE), or Azure Kubernetes Service (AKS). The containers may support machine learning frameworks such as TensorFlow, PyTorch, and/or other suitable frameworks. The process continues to step 550, where training images are input into the neural network system. The neural network may support a triplet loss function, and the input training data can include anchor data, positive data, and negative data. The input training data can be in the form of image tuples that include EO image data and corresponding SAR image data.

### Multi-Modal Fusion System Architecture

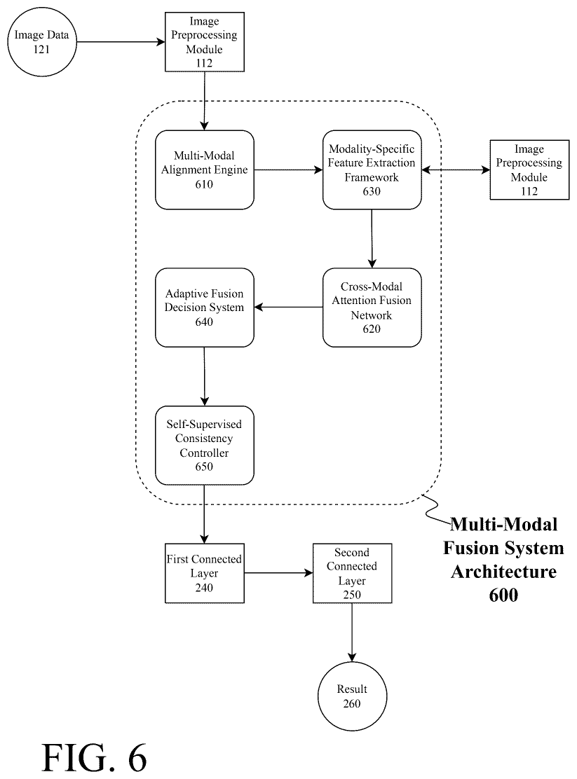

FIG. 6 is a block diagram illustrating exemplary architecture of multi-modal fusion system 600, in an embodiment. Multi-modal fusion system 600 enhances image classification capabilities by combining information from electro-optical (EO) images and synthetic aperture radar (SAR) images. System 600 builds upon previously described systems while introducing specialized components focused on fusion techniques.

Multi-modal alignment engine 610 addresses the misalignment problem between EO and SAR images. Alignment engine 610 receives preprocessed EO and SAR images from image preprocessing module 112 shown in FIG. 1. Alignment engine 610 performs feature-level registration rather than attempting pixel-level alignment, which can be particularly challenging with these disparate modalities. For example, alignment engine 610 may implement spatial transformer networks that learn to predict transformation parameters between feature maps. In some embodiments, alignment engine 610 may utilize correlation layers to compute feature correspondences in high-dimensional space, which are less sensitive to modality-specific appearance differences than raw pixel values. Alignment engine 610 may include, in an embodiment, a neural network trained specifically for the alignment task using paired EO-SAR images with known correspondence points. This alignment network might be trained using a combination of supervised losses from manually annotated correspondences and self-supervised losses that maximize mutual information between aligned features. The alignment model may be implemented as a CNN-based architecture, a graph neural network that models spatial relationships, or a transformer architecture that captures long-range dependencies between features. Alignment engine 610 maintains compatibility with flip, rotation, and affine transform operations described previously while extending capabilities to handle deformable transformations that can account for non-rigid differences between modalities.

Cross-modal attention fusion network 620 represents the core component for integrating information across modalities. Fusion network 620 applies bi-directional attention mechanisms between features extracted from EO and SAR images. In certain embodiments, fusion network 620 may implement scaled dot-product attention calculations similar to those found in transformer architectures, where attention weights are computed as softmax (QK\hat{ }T/√d), with Q representing query features from one modality and K representing key features from the other modality. Fusion network 620 may include, in an embodiment, multiple attention heads operating in parallel, each potentially focusing on different aspects of cross-modal relationships such as spatial correspondence, semantic similarity, or complementary information. For instance, some attention heads might focus on regions where SAR provides critical information (like areas in shadow in EO images), while others might emphasize features that are more reliably detected in EO imagery (such as color patterns). The fusion network may be trained using a combination of supervised classification loss and auxiliary losses that promote effective information exchange between modalities. In some implementations, fusion network 620 may incorporate residual connections to preserve modality-specific information alongside fused representations. The network architecture may consist of stacked attention blocks with feed-forward networks between them, potentially including layer normalization for training stability. Fusion network 620 dynamically weights features based on their relevance and reliability, then feeds enhanced representations to the backbone layer 230 from FIG. 2.

Modality-specific feature extraction framework 630 enhances backbone layer 230 by creating parallel specialized branches for EO and SAR modalities. Framework 630 optimizes feature extraction for each modality's unique characteristics using specialized convolutional filters. For example, the SAR-specific branch may employ dilated convolutions to capture contextual information at multiple scales without increasing computational complexity. In some embodiments, framework 630 may incorporate squeeze-and-excitation blocks that recalibrate channel-wise feature responses adaptively based on the information content in each channel. The EO-specific branch might include, in an embodiment, color-sensitive filters and texture-aware convolutions that can identify visual patterns not present in SAR data. Framework 630 may be trained using a progressive training strategy where each modality-specific branch is first pre-trained on single-modality data before joint fine-tuning. The feature extractors could be implemented using various architectural patterns including residual connections, dense connections, or inception-style multi-scale processing. In certain implementations, framework 630 may also include modality-specific normalization techniques calibrated to the statistical properties of each sensing type, such as batch normalization for EO data and instance normalization for SAR data to handle their different statistical distributions. Framework 630 maintains compatibility with ResNet-34, EfficientNet-B0, or Swin-T backbone options described in the original neural network system module 116 while extending their capabilities through modality-specific processing.

Adaptive fusion decision system 640 dynamically determines optimal fusion strategies based on image quality assessment. Decision system 640 compensates for missing or degraded data in either modality by employing uncertainty-aware fusion strategies. For instance, decision system 640 may implement a mixture of experts approach where multiple fusion strategies are combined based on their estimated effectiveness for each input pair. In some embodiments, decision system 640 may utilize Monte Carlo dropout during inference to generate multiple predictions with different dropout patterns, allowing for uncertainty estimation in each modality's predictions. The system might include, in an embodiment, a meta-network that analyzes image quality metrics (such as contrast, noise level, or feature distinctiveness) to predict optimal fusion weights. This meta-network could be trained using reinforcement learning where the reward signal is based on classification accuracy on a validation set. In certain implementations, decision system 640 may employ information bottleneck methods to filter out irrelevant or noisy features from each modality before fusion. The fusion strategies might include, for example, weighted averaging, feature concatenation, bilinear pooling, or attention-based selection depending on the estimated reliability of each modality. Decision system 640 may be implemented using Bayesian neural networks, fuzzy logic controllers, or ensemble methods that support uncertainty reasoning. Decision system 640 connects with first connected layer 240 and second connected layer 250 of original neural network architecture shown in FIG. 2.

Self-supervised consistency controller 650 ensures consistent representations across modalities. Consistency controller 650 leverages contrastive learning between EO-SAR pairs and applies cross-modal consistency losses that ensure features from both modalities represent the same semantic content. For example, controller 650 may implement a contrastive loss function that pulls together representations of the same scene across modalities while pushing apart representations of different scenes. In certain embodiments, consistency controller 650 may utilize a Siamese network architecture with weight sharing between modality-specific branches to promote feature alignment. The controller might include, in an embodiment, a feature reconstruction component that attempts to predict features in one modality given features from the other, encouraging the network to learn a shared semantic space. This reconstruction component could be trained using mean squared error, perceptual losses, or adversarial losses that distinguish between real and reconstructed features. In some implementations, consistency controller 650 may incorporate curriculum learning strategies that progressively increase the difficulty of consistency tasks, starting with easy examples (clear, high-quality images in both modalities) and gradually introducing more challenging scenarios (degraded or partially obscured images). The controller may employ several loss terms including InfoNCE loss, triplet losses with cross-modal sampling, or mutual information maximization objectives. Consistency controller 650 may be trained on paired EO-SAR data with various augmentations to improve robustness to domain shifts. Consistency controller 650 complements triplet mining approach from label splitting module 114 by extending it to consider cross-modal relationships.

In operation of an embodiment, data flows through multi-modal fusion system 600 in a sequential manner while allowing for feedback connections during training phases. Acquired EO and SAR image data 121 enters the system through image preprocessing module 112, which performs initial manipulations including resizing, rotation, flipping, and contrast adjustments to prepare the data for neural network processing. Preprocessed images are then passed to multi-modal alignment engine 610 for feature-level registration, where deformable convolutions and spatial transformer networks identify correspondences between modalities without requiring pixel-perfect alignment. Aligned feature maps flow to modality-specific feature extraction framework 630, which creates parallel specialized pathways extending from backbone layer 230, with dedicated branches optimized for the unique characteristics of EO and SAR data. Extracted modality-specific features are then processed by cross-modal attention fusion network 620, which identifies complementary information across modalities using transformer-based attention mechanisms that dynamically weight features based on their relevance and reliability. Adaptive fusion decision system 640 determines the optimal fusion strategy based on assessed image quality and confidence metrics, employing Bayesian neural network components to estimate uncertainty in each modality. Self-supervised consistency controller 650 refines these fused representations to ensure semantic consistency between EO and SAR features through contrastive learning objectives. These enhanced feature representations then flow into first connected layer 240, which performs initial dimensionality reduction and feature transformation. The output from first connected layer 240 is subsequently processed by second connected layer 250, which performs final feature refinement before producing object classification result 260 including category, subcategory, and confidence level information. This sequential architecture maintains the fundamental structure of the original neural network system while incorporating the specialized fusion components that enable robust cross-modal integration.

Multi-modal fusion system 600 addresses limitations identified in processing EO and SAR images by leveraging strengths of both modalities while compensating for their respective weaknesses. This fusion approach is particularly valuable when one modality suffers from degradation, such as when EO images are impacted by poor lighting or weather conditions, or when SAR images contain ambiguous returns. System 600 maintains backward compatibility with existing components while significantly extending classification capabilities through advanced fusion techniques.

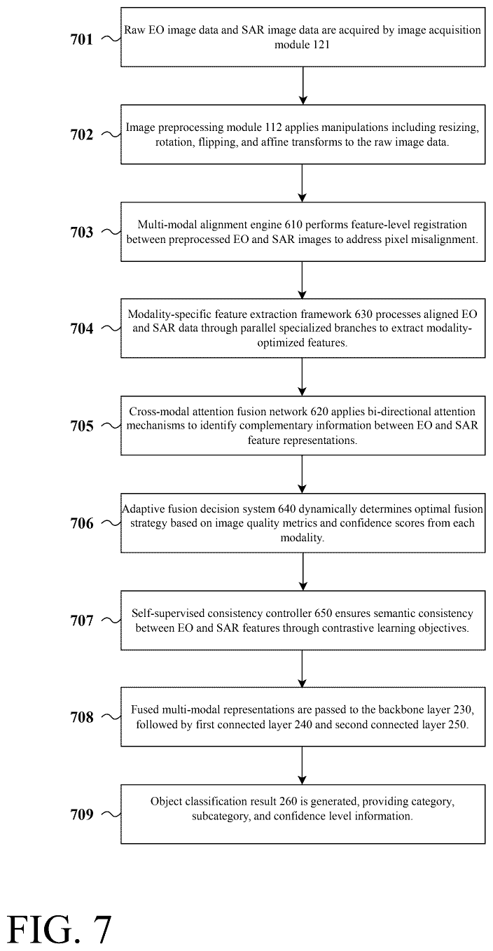

FIG. 7 is a method diagram illustrating the multi-modal fusion pipeline of multi-modal fusion system 600, in an embodiment. Raw EO image data and SAR image data are acquired by image acquisition module 121 from aerial or satellite sensors 701. Image preprocessing module 112 applies manipulations including resizing to standardized dimensions, geometric operations such as rotation and flipping, contrast adjustments, and affine transforms to the raw image data to prepare it for neural network processing 702. Multi-modal alignment engine 610 performs feature-level registration between preprocessed EO and SAR images to address pixel misalignment using deformable convolutions and spatial transformer networks that identify corresponding features in high-dimensional space rather than attempting direct pixel alignment 703. Modality-specific feature extraction framework 630 processes aligned EO and SAR data through parallel specialized branches to extract modality-optimized features, where SAR-specific branches employ dilated convolutions to handle speckle noise and coherent imaging artifacts while EO-specific branches utilize color-sensitive filters and texture-aware convolutions 704. Cross-modal attention fusion network 620 applies bi-directional attention mechanisms to identify complementary information between EO and SAR feature representations using transformer-based attention blocks with multi-head attention that computes query-key-value operations across modalities to highlight areas where one modality provides critical information missing in the other 705. Adaptive fusion decision system 640 dynamically determines optimal fusion strategy based on image quality metrics and confidence scores from each modality, employing Bayesian neural network components to estimate uncertainty and applying entropy-based weighting mechanisms that assign importance based on information content 706. Self-supervised consistency controller 650 ensures semantic consistency between EO and SAR features through contrastive learning objectives that bring together representations of the same scene across modalities while pushing apart representations of different scenes 707. Fused multi-modal representations are passed to the backbone layer 230, which may be implemented as ResNet-34, EfficientNet-B0, or Swin-T architecture, followed by first connected layer 240 and second connected layer 250, which progressively refine the feature representations for final classification 708. Object classification result 260 is generated, providing category information such as vehicle type, subcategory distinctions, and confidence level based on the multi-modal analysis, with particularly improved performance in challenging conditions where one modality may be degraded 709.

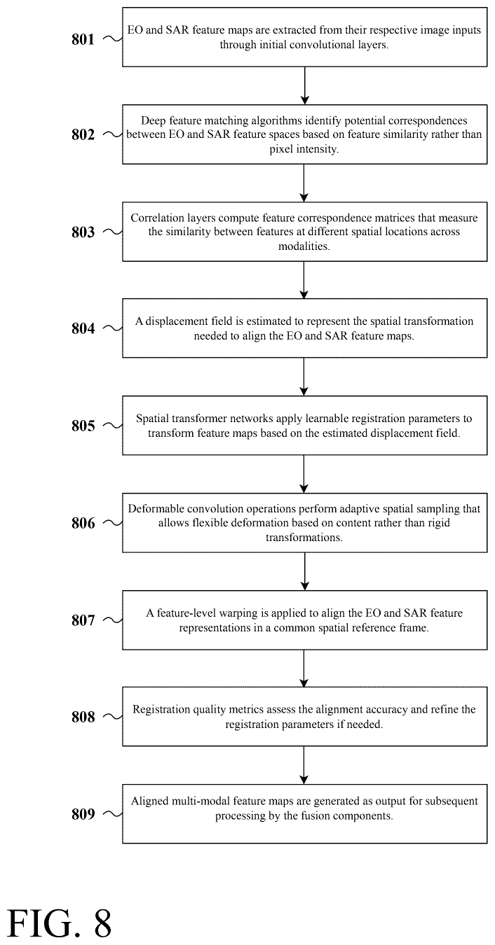

FIG. 8 is a method diagram illustrating the feature-level registration process performed by multi-modal alignment engine 610, in an embodiment. EO and SAR feature maps are extracted from their respective image inputs through initial convolutional layers that transform raw pixel data into high-dimensional feature representations suitable for correspondence analysis 801. Deep feature matching algorithms identify potential correspondences between EO and SAR feature spaces based on feature similarity rather than pixel intensity, which allows the system to bridge the significant appearance gaps between these disparate modalities 802. Correlation layers compute feature correspondence matrices that measure the similarity between features at different spatial locations across modalities, creating a dense similarity volume that highlights regions with matching semantic content despite different visual appearances 803. A displacement field is estimated to represent the spatial transformation needed to align the EO and SAR feature maps, encoding the pixel-wise or region-wise movements required to bring corresponding features into alignment 804. Spatial transformer networks apply learnable registration parameters to transform feature maps based on the estimated displacement field, implementing a differentiable transformation that can be optimized during training 805. Deformable convolution operations perform adaptive spatial sampling that allows flexible deformation based on content rather than rigid transformations, enabling the alignment of features that may appear at different scales or with different geometric distortions across modalities 806. A feature-level warping is applied to align the EO and SAR feature representations in a common spatial reference frame, producing spatially corresponding feature maps while preserving the modality-specific information content 807. Registration quality metrics assess the alignment accuracy and refine the registration parameters if needed, utilizing mutual information measures and feature consistency checks to evaluate how well the alignment process has succeeded 808. Aligned multi-modal feature maps are generated as output for subsequent processing by the fusion components, providing a foundation for effective information integration across the EO and SAR modalities 809.

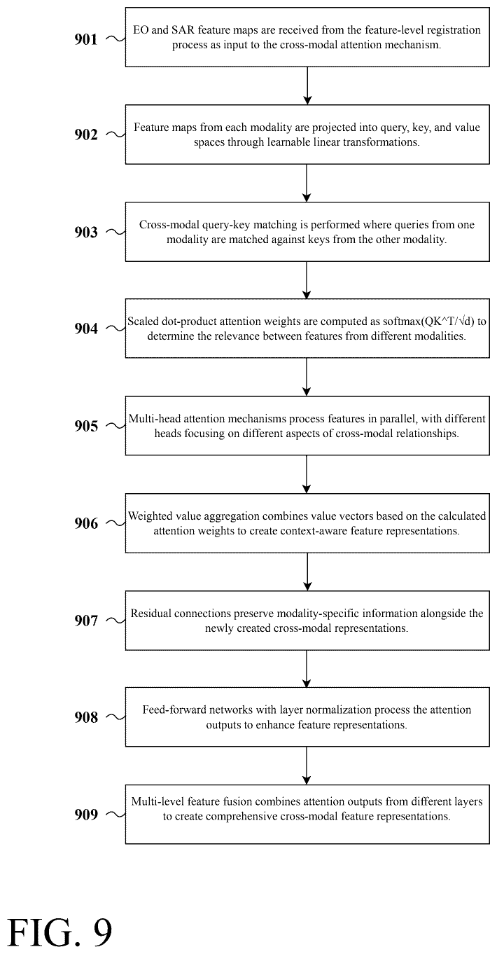

FIG. 9 is a method diagram illustrating the cross-modal attention mechanism employed by cross-modal attention fusion network 620, in an embodiment. EO and SAR feature maps are received from the feature-level registration process as input to the cross-modal attention mechanism, with spatial correspondence already established between the modalities 901. Feature maps from each modality are projected into query, key, and value spaces through learnable linear transformations, creating representations that facilitate the attention computation process across the different sensing modalities 902. Cross-modal query-key matching is performed where queries from one modality are matched against keys from the other modality, enabling the system to identify where information in one modality should attend to information in the complementary modality 903. Scaled dot-product attention weights are computed as softmax (QK\hat{ }T/√d) to determine the relevance between features from different modalities, where the scaling factor √d prevents the dot products from growing too large in magnitude as the feature dimension increases 904. Multi-head attention mechanisms process features in parallel, with different heads focusing on different aspects of cross-modal relationships, such as some heads emphasizing regions where SAR provides critical information in shadowed EO areas while others focus on areas where EO details complement SAR structural information 905. Weighted value aggregation combines value vectors based on the calculated attention weights to create context-aware feature representations that incorporate the most relevant information from both modalities 906. Residual connections preserve modality-specific information alongside the newly created cross-modal representations, ensuring that unique characteristics of each sensing type are not lost during the fusion process 907. Feed-forward networks with layer normalization process the attention outputs to enhance feature representations, applying non-linear transformations that increase the representational power of the fused features while maintaining stable training dynamics 908. Multi-level feature fusion combines attention outputs from different layers to create comprehensive cross-modal feature representations that capture both fine-grained details and higher-level semantic concepts across the EO and SAR modalities 909.

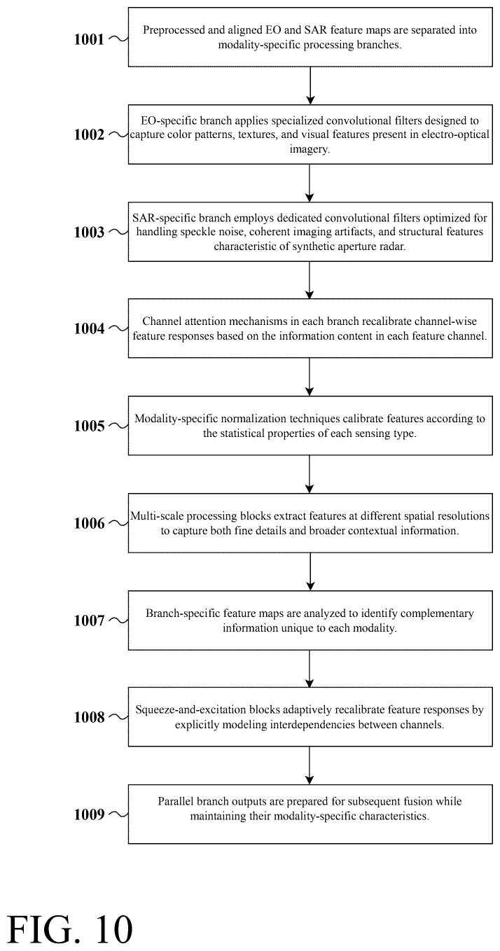

FIG. 10 is a method diagram illustrating the modality-specific feature extraction branching process implemented by framework 630, in an embodiment. Preprocessed and aligned EO and SAR feature maps are separated into modality-specific processing branches that allow specialized handling of each data type's unique characteristics 1001. EO-specific branch applies specialized convolutional filters designed to capture color patterns, textures, and visual features present in electro-optical imagery, with particular emphasis on edge detection, color gradients, and natural scene statistics that are relevant for object recognition in visible spectrum data 1002. SAR-specific branch employs dedicated convolutional filters optimized for handling speckle noise, coherent imaging artifacts, and structural features characteristic of synthetic aperture radar, utilizing dilated convolutions to expand the receptive field without increasing computational complexity 1003. Channel attention mechanisms in each branch recalibrate channel-wise feature responses based on the information content in each feature channel, dynamically emphasizing the most informative aspects of the signal while suppressing less relevant components 1004. Modality-specific normalization techniques calibrate features according to the statistical properties of each sensing type, with batch normalization for EO data and instance normalization for SAR data to account for their different statistical distributions and noise characteristics 1005. Multi-scale processing blocks extract features at different spatial resolutions to capture both fine details and broader contextual information, implementing parallel pathways with different kernel sizes or using inception-style architectures that enable the network to process patterns at multiple scales simultaneously 1006. Branch-specific feature maps are analyzed to identify complementary information unique to each modality, creating representations that highlight the strengths of each sensing type while preparing for efficient fusion in subsequent stages 1007. Squeeze-and-excitation blocks adaptively recalibrate feature responses by explicitly modeling interdependencies between channels, first “squeezing” spatial information into channel descriptors and then “exciting” or reweighting channels to enhance informativeness 1008. Parallel branch outputs are prepared for subsequent fusion while maintaining their modality-specific characteristics, ensuring that the unique information contributed by each sensing modality is preserved for the cross-modal attention fusion network 1009.

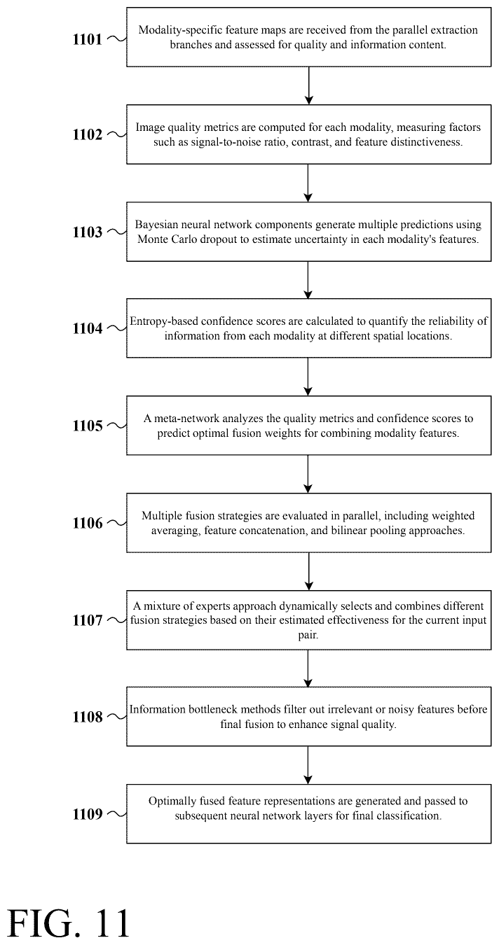

FIG. 11 is a method diagram illustrating the adaptive fusion decision system 640, in an embodiment. Modality-specific feature maps are received from the parallel extraction branches and assessed for quality and information content, establishing a foundation for intelligent fusion decisions 1101. Image quality metrics are computed for each modality, measuring factors such as signal-to-noise ratio, contrast, and feature distinctiveness, which provide objective assessments of how reliable each modality's information might be for the current input 1102. Bayesian neural network components generate multiple predictions using Monte Carlo dropout to estimate uncertainty in each modality's features, creating confidence intervals around feature values rather than single point estimates 1103. Entropy-based confidence scores are calculated to quantify the reliability of information from each modality at different spatial locations, with lower entropy indicating more certain and potentially more reliable features 1104. A meta-network analyzes the quality metrics and confidence scores to predict optimal fusion weights for combining modality features, functioning as a learned decision mechanism that improves with experience across diverse input conditions 1105. Multiple fusion strategies are evaluated in parallel, including weighted averaging for balanced information, feature concatenation for preserving distinct modality characteristics, and bilinear pooling approaches for capturing higher-order relationships between modalities 1106. A mixture of experts approach dynamically selects and combines different fusion strategies based on their estimated effectiveness for the current input pair, adapting the fusion method to suit the specific characteristics of each EO-SAR image tuple being processed 1107. Information bottleneck methods filter out irrelevant or noisy features before final fusion to enhance signal quality, implementing a form of attention that focuses only on the most informative aspects of each modality 1108. Optimally fused feature representations are generated and passed to subsequent neural network layers for final classification, with the fusion weights and strategies automatically adapted to maximize performance even when one modality suffers from degradation or contains ambiguous information 1109.

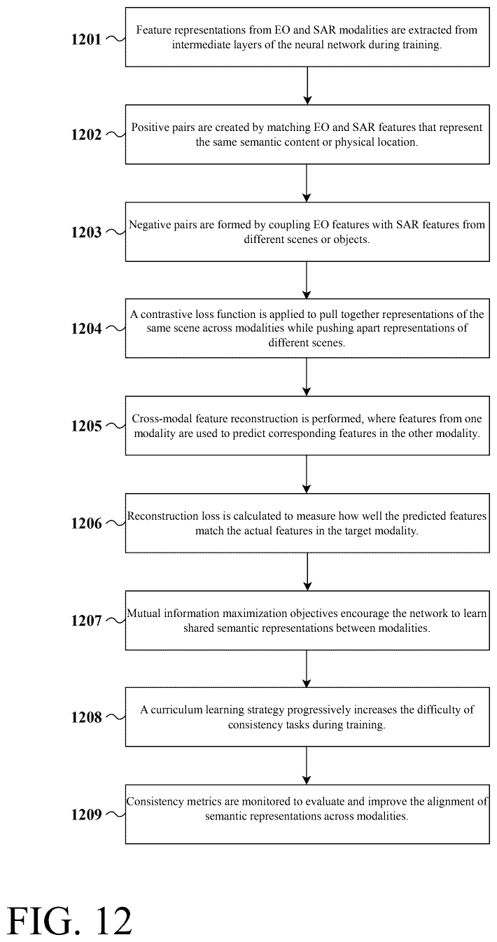

FIG. 12 is a method diagram illustrating the self-supervised consistency control process implemented by controller 650, in an embodiment. Feature representations from EO and SAR modalities are extracted from intermediate layers of the neural network during training, providing raw material for establishing cross-modal consistency relationships 1201. Positive pairs are created by matching EO and SAR features that represent the same semantic content or physical location, utilizing the spatial alignment provided by the multi-modal alignment engine 610 to identify corresponding regions across modalities 1202. Negative pairs are formed by coupling EO features with SAR features from different scenes or objects, creating contrasting examples that help the network learn to distinguish between matched and unmatched cross-modal representations 1203. A contrastive loss function is applied to pull together representations of the same scene across modalities while pushing apart representations of different scenes, using a temperature-scaled softmax formulation that creates well-structured embedding spaces 1204. Cross-modal feature reconstruction is performed, where features from one modality are used to predict corresponding features in the other modality, implementing a form of self-supervision that does not require additional annotations 1205. Reconstruction loss is calculated to measure how well the predicted features match the actual features in the target modality, using metrics such as mean squared error, perceptual losses, or adversarial losses that distinguish between real and reconstructed features 1206. Mutual information maximization objectives encourage the network to learn shared semantic representations between modalities, ensuring that the information content is consistent despite the different appearance characteristics of EO and SAR imagery 1207. A curriculum learning strategy progressively increases the difficulty of consistency tasks during training, starting with easy examples featuring clear, high-quality images in both modalities and gradually introducing more challenging scenarios with degraded or partially obscured images 1208. Consistency metrics are monitored to evaluate and improve the alignment of semantic representations across modalities, providing quantitative feedback that guides optimization of the self-supervised learning process and ensures robust cross-modal feature correspondence 1209.

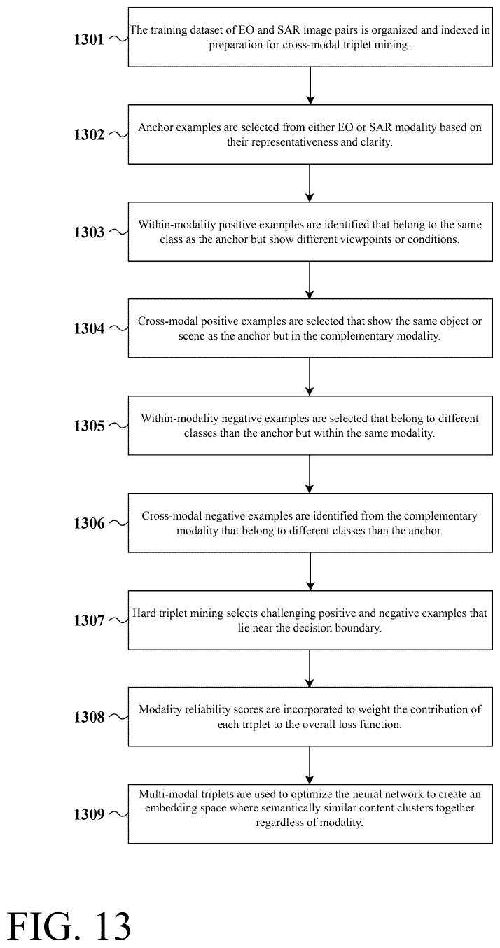

FIG. 13 is a method diagram illustrating the cross-modal triplet mining process, in an embodiment. The training dataset of EO and SAR image pairs is organized and indexed in preparation for cross-modal triplet mining, with metadata from label splitting module 114 providing category and subcategory information to guide the selection process 1301. Anchor examples are selected from either EO or SAR modality based on their representativeness and clarity, establishing reference points around which positive and negative relationships will be defined across both sensing modalities 1302. Within-modality positive examples are identified that belong to the same class as the anchor but show different viewpoints or conditions, helping the network learn invariance to pose, lighting, or sensor-specific variations while maintaining class consistency 1303. Cross-modal positive examples are selected that show the same object or scene as the anchor but in the complementary modality, teaching the network to recognize semantic equivalence despite the fundamental differences in appearance between EO and SAR imagery 1304. Within-modality negative examples are selected that belong to different classes than the anchor but within the same modality, establishing clear classification boundaries within each sensing domain 1305. Cross-modal negative examples are identified from the complementary modality that belong to different classes than the anchor, reinforcing the network's ability to distinguish between different objects regardless of which sensor captured them 1306. Hard triplet mining selects challenging positive and negative examples that lie near the decision boundary, focusing computational resources on difficult cases where the embedding distances are not yet optimal according to the desired margin. 1307. Modality reliability scores are incorporated to weight the contribution of each triplet to the overall loss function, giving greater importance to examples where both modalities provide clear, reliable information 1308. Multi-modal triplets are used to optimize the neural network to create an embedding space where semantically similar content clusters together regardless of modality, enabling robust classification even when one sensing type provides degraded or ambiguous information 1309.

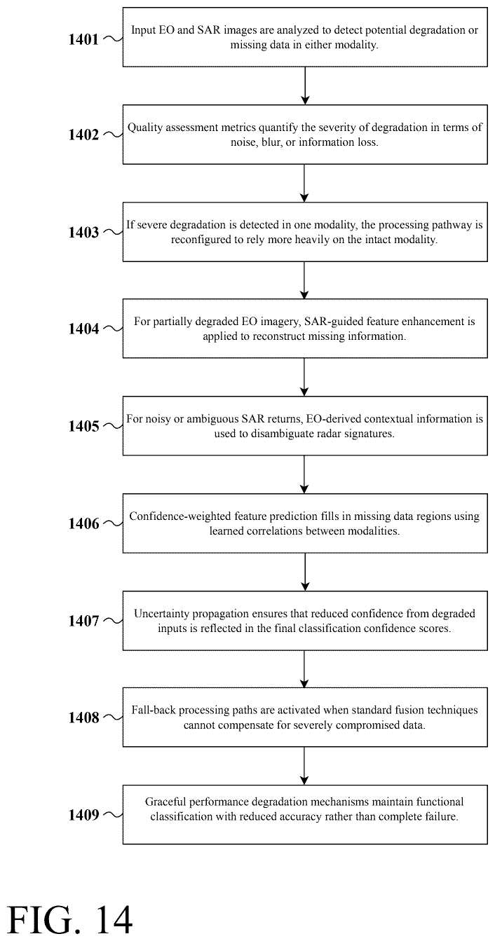

FIG. 14 is a method diagram illustrating failure mode handling by the multi-modal fusion system 600, in an embodiment. Input EO and SAR images are analyzed to detect potential degradation or missing data in either modality, with automated quality checks identifying issues such as cloud cover in EO imagery or radar shadowing in SAR data 1401. Quality assessment metrics quantify the severity of degradation in terms of noise, blur, or information loss, providing numerical scores that guide subsequent processing decisions to optimize system performance despite input limitations 1402. If severe degradation is detected in one modality, the processing pathway is reconfigured to rely more heavily on the intact modality, with adaptive fusion decision system 640 adjusting fusion weights to minimize the influence of compromised data sources 1403. For partially degraded EO imagery, SAR-guided feature enhancement is applied to reconstruct missing information, leveraging the all-weather capability of radar to provide structural information that complements or replaces obscured visual features 1404. For noisy or ambiguous SAR returns, EO-derived contextual information is used to disambiguate radar signatures, helping to resolve confusion between similar radar cross-sections by incorporating visual appearance characteristics when available 1405. Confidence-weighted feature prediction fills in missing data regions using learned correlations between modalities, implementing a form of cross-modal inpainting that maintains classification performance even with incomplete sensor data 1406. Uncertainty propagation ensures that reduced confidence from degraded inputs is reflected in the final classification confidence scores, providing transparent reliability metrics rather than potentially misleading high-confidence errors 1407. Fall-back processing paths are activated when standard fusion techniques cannot compensate for severely compromised data, implementing specialized models trained specifically for single-modality operation when one sensor channel is completely unavailable 1408. Graceful performance degradation mechanisms maintain functional classification with reduced accuracy rather than complete failure, preserving core system capabilities even under challenging operational conditions where ideal multi-modal data cannot be obtained 1409.

In a non-limiting use case example of multi-modal fusion system 600, the system is deployed for urban infrastructure monitoring following a major flooding event. A government emergency management agency needs to rapidly assess damage to critical infrastructure such as bridges, roads, and power distribution systems. Weather conditions remain problematic with intermittent cloud cover and occasional rain, creating challenging conditions for traditional remote sensing.

The agency deploys an aircraft equipped with both EO imaging systems and SAR sensors that fly over the affected region. The EO system provides high-resolution visual imagery with accurate color information when weather permits, while the SAR system delivers radar-based imagery that penetrates cloud cover and can operate regardless of lighting conditions.

Initially, image acquisition module 121 collects raw data from both sensors. The EO imagery shows excellent detail in some areas but suffers from cloud obscuration in approximately 40% of the coverage area. The SAR imagery provides complete coverage but contains typical radar artifacts such as speckle noise and ambiguous returns from certain complex urban structures.

Image preprocessing module 112 performs necessary manipulations on both data types, including geometric corrections to account for aircraft motion, image resizing to standardize dimensions to 224×224 pixels, and contrast enhancement particularly for the EO imagery to improve visibility in shadowed areas. The module also applies speckle filtering to the SAR data to reduce noise while preserving structural information.

Multi-modal alignment engine 610 then addresses the critical challenge of aligning the EO and SAR data, which have fundamentally different appearance characteristics. Rather than attempting pixel-level registration, the engine identifies corresponding features in high-dimensional feature space. For example, the distinctive pattern of a highway interchange is recognized in both modalities despite appearing visually different—as asphalt roadways in EO imagery and as strong linear reflectors in SAR imagery.

The modality-specific feature extraction framework 630 processes each data type through specialized pathways. The EO branch employs convolutional filters optimized for color patterns and textural information, successfully identifying partially submerged roadways by their distinctive pavement patterns and discoloration from water damage. Simultaneously, the SAR branch uses dilated convolutions that excel at capturing structural information, detecting metal infrastructure like damaged power line towers based on their strong radar returns even when obscured by clouds in the EO imagery.

When analyzing a particular bridge of concern, the cross-modal attention fusion network 620 identifies complementary information across the modalities. The EO imagery provides clear evidence of water levels and visible structural damage to the bridge's upper surface, while the SAR data reveals potential scouring around submerged support pillars that aren't visible in the optical imagery. The attention mechanism focuses on these complementary aspects, dynamically weighting features to create a comprehensive representation of the bridge's condition.

The adaptive fusion decision system 640 recognizes that for specific regions completely obscured by clouds, the EO data has very low confidence scores. In these areas, the system automatically adjusts its fusion strategy to rely more heavily on SAR information. Conversely, in areas where complex radar reflections create ambiguous SAR returns, the system leverages the clear visual information from EO imagery when available.

Self-supervised consistency controller 650 ensures that the semantic interpretation remains consistent across modalities. For instance, it verifies that a section of roadway identified in the EO imagery maintains the same classification when observed in the SAR imagery, even though the appearance characteristics differ substantially between the two sensing types.

The enhanced feature representations flow through the neural network's connected layers, with first connected layer 240 performing dimensionality reduction while preserving critical damage indicators, and second connected layer 250 refining these features for final classification. The object classification result 260 successfully identifies and categorizes infrastructure elements according to damage severity, providing not only object type identification (e.g., “bridge,” “power distribution tower,” “highway section”) but also damage assessment subcategories (e.g., “severely compromised,” “moderately damaged,” “intact but at risk”) with associated confidence levels.

This comprehensive analysis enables emergency responders to prioritize their efforts, focusing first on critically damaged infrastructure while also identifying at-risk structures that require monitoring. The multi-modal approach proves particularly valuable as changing weather conditions throughout the day would have made reliance on EO imagery alone impractical, while SAR-only analysis would have missed important visual indicators of damage visible only in the optical spectrum.

One skilled in the art would recognize numerous practical applications for multi-modal fusion system 600 beyond the examples described herein. The system's ability to integrate information from electro-optical and synthetic aperture radar imagery makes it particularly valuable across diverse domains including defense and intelligence for enhanced target recognition, disaster response for damage assessment regardless of weather conditions, precision agriculture for crop monitoring through varying seasons, urban planning for comprehensive infrastructure analysis, environmental monitoring for tracking deforestation and land use changes, maritime surveillance for vessel detection in all weather conditions, and transportation infrastructure management for identifying maintenance needs across road and rail networks. These examples are presented as non-limiting illustrations of the system's potential applications, and it should be understood that the architectures, methods, and processes described herein could be adapted to other sensing modalities beyond EO and SAR, potentially including infrared, multispectral, hyperspectral, or LIDAR data sources. Furthermore, while vehicle classification is emphasized in exemplary embodiments, the system is equally applicable to identifying and classifying other objects of interest such as buildings, vegetation types, geological features, or maritime vessels. The specific implementation details, neural network architectures, and processing algorithms may vary based on the particular application domain, available computational resources, and specific performance requirements without departing from the scope of the invention as claimed.

### Exemplary Computing Environment

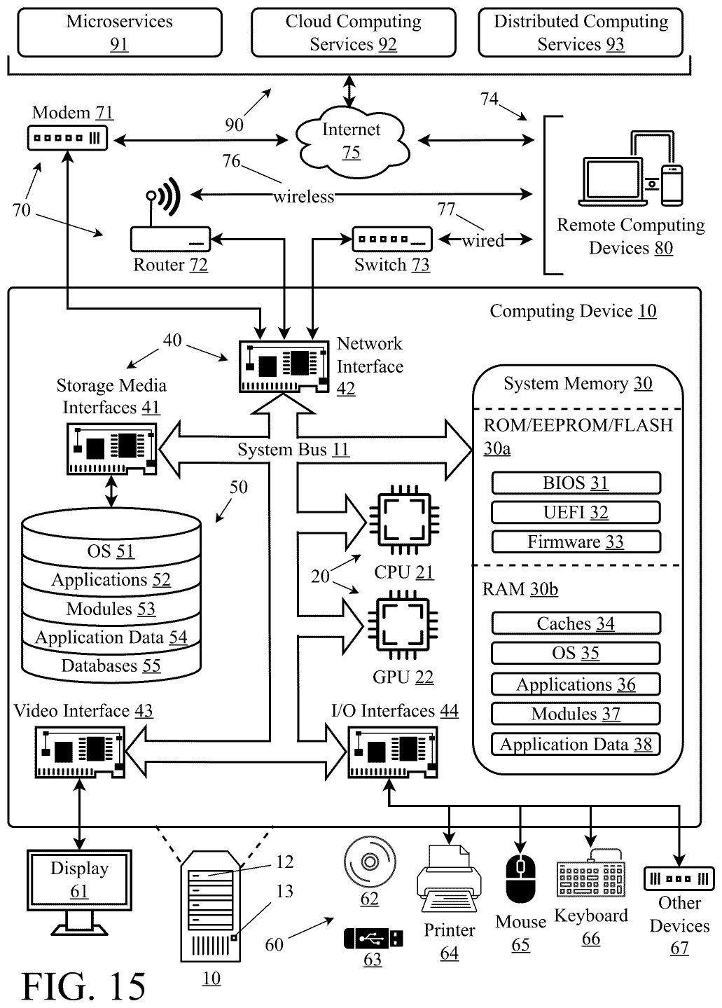

FIG. 15 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can now be appreciated, disclosed embodiments provide improvements in object classification of image data that includes EO images and/or SAR images. Disclosed embodiments are well-suited for automatic identification of objects in images from aerial and/or satellite imagery. Automating the classification process reduces the need for manual intervention, leading to faster analysis of satellite images and quicker decision-making. Additionally, by reducing the need for manual labor, automatic classification provided by disclosed embodiments can serve to lower the overall cost of analyzing satellite and/or aerial images. Moreover, automated classification methods can provide objective and repeatable analysis, reducing the potential for bias in the interpretation of satellite and/or aerial images. Thus, disclosed embodiments provide automatic object classification in EO and/or SAR image data that enhances the efficiency, scalability, accuracy, and timeliness of the image analysis, making disclosed embodiments valuable for various applications in environmental monitoring, urban planning, agriculture, and more.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
acquire a plurality of training images, wherein the training images include multiple sets of electro-optical images and synthetic aperture radar images;
perform one or more image manipulations on the training images;
augment the training images with metadata, wherein the metadata includes category information;
implement a neural network system that includes a backbone layer, a first connected layer, and a second connected layer;
implement a multi-modal alignment engine that performs feature-level registration between the electro-optical images and synthetic aperture radar images;
implement a cross-modal attention fusion network that applies bi-directional attention mechanisms between features extracted from the electro-optical images and synthetic aperture radar images; and
input the plurality of training images into the neural network system.

2. The computer system of claim 1, wherein the software instructions further implement an adaptive fusion decision system that dynamically determines fusion strategies based on image quality metrics and confidence scores from each modality.

3. The computer system of claim 1, wherein the software instructions further implement a modality-specific feature extraction framework that creates parallel specialized branches for the electro-optical images and synthetic aperture radar images.

4. The computer system of claim 1, wherein the software instructions further implement a self-supervised consistency controller that applies contrastive learning objectives between electro-optical and synthetic aperture radar feature representations.

5. The computer system of claim 2, wherein the adaptive fusion decision system employs uncertainty-aware fusion strategies that include Bayesian neural network components to estimate uncertainty in each modality.

6. The computer system of claim 1, wherein the cross-modal attention fusion network includes transformer-based attention blocks with multi-head attention mechanisms that capture different aspects of cross-modal relationships.

7. The computer system of claim 1, wherein the software instructions further cause the computer system to utilize a KD-tree for appearance labeling and perform triplet mining on the plurality of training images, wherein the triplet mining considers cross-modal relationships.

8. The computer system of claim 1, wherein the backbone layer of the neural network system is implemented as one of: a ResNet-34 layer, an EfficientNet-B0 layer, or a Swin-T layer.

9. The computer system of claim 1, wherein the multi-modal alignment engine employs deformable convolution operations that allow for adaptive spatial sampling based on content.

10. The computer system of claim 3, wherein the modality-specific feature extraction framework includes SAR-specific convolutional filters designed to handle speckle noise and EO-specific feature extractors optimized for color and texture patterns.

11. A computer-implemented method for image classification comprising:
acquiring a plurality of training images, wherein the training images include multiple sets of electro-optical images and synthetic aperture radar images;
performing one or more image manipulations on the training images;
augmenting the training images with metadata, wherein the metadata includes category information;
implementing a neural network system that includes a backbone layer, a first connected layer, and a second connected layer;
implementing a multi-modal alignment engine that performs feature-level registration between the electro-optical images and synthetic aperture radar images;
implementing a cross-modal attention fusion network that applies bi-directional attention mechanisms between features extracted from the electro-optical images and synthetic aperture radar images; and
inputting the plurality of training images into the neural network system.

12. The computer-implemented method of claim 11, further comprising implementing an adaptive fusion decision system that dynamically determines fusion strategies based on image quality metrics and confidence scores from each modality.

13. The computer-implemented method of claim 11, further comprising implementing a modality-specific feature extraction framework that creates parallel specialized branches for the electro-optical images and synthetic aperture radar images.

14. The computer-implemented method of claim 11, further comprising implementing a self-supervised consistency controller that applies contrastive learning objectives between electro-optical and synthetic aperture radar feature representations.

15. The computer-implemented method of claim 12, wherein the adaptive fusion decision system employs uncertainty-aware fusion strategies that include Bayesian neural network components to estimate uncertainty in each modality.

16. The computer-implemented method of claim 11, wherein the cross-modal attention fusion network includes transformer-based attention blocks with multi-head attention mechanisms that capture different aspects of cross-modal relationships.

17. The computer-implemented method of claim 11, further comprising utilizing a KD-tree for appearance labeling and performing triplet mining on the plurality of training images, wherein the triplet mining considers cross-modal relationships.

18. The computer-implemented method of claim 11, wherein the backbone layer of the neural network system is implemented as one of: a ResNet-34 layer, an EfficientNet-B0 layer, or a Swin-T layer.

19. The computer-implemented method of claim 11, wherein the multi-modal alignment engine employs deformable convolution operations that allow for adaptive spatial sampling based on content.

20. The computer-implemented method of claim 13, wherein the modality-specific feature extraction framework includes SAR-specific convolutional filters designed to handle speckle noise and EO-specific feature extractors optimized for color and texture patterns.
